(19) United States
(12) Patent Application Publication
(10) Pub. No.: US 2014/0126454 A1
(43) Pub. Date: May 8, 2014

(54) EMBMS SUPPORT IN HETEROGENEOUS NETWORK

(71) Applicant: QUALCOMM INCORPORATED, San Diego, CA (US)

(72) Inventors: Xiaoxia Zhang, San Diego, CA (US); Durga Prasad Malladi, San Diego, CA (US); Jun Wang, San Diego, CA (US)

(73) Assignee: QUALCOMM INCORPORATED, San Diego, CA (US)

(21) Appl. No.: 13/787,161

(22) Filed: Mar. 6, 2013

Related U.S. Application Data
(60) Provisional application No. 61/722,666, filed on Nov. 5, 2012.

(51) Int. Cl. H04W 4/06

(52) U.S. Cl. CPC H04W 4/06
USPC 370/312

(57) ABSTRACT

A method, an apparatus, and a computer program product for wireless communication at a node are provided. The apparatus receives a multicast-broadcast single frequency network (MBSFN) signal transmitted from a base station, decodes the received MBSFN signal, and retrieves at least one source symbol from the decoded MBSFN signal when the node is capable of retrieving a source symbol. The apparatus also generates at least one redundancy version of the MBSFN signal based on the retrieved at least one source symbol and transmits the at least one redundancy version of the MBSFN signal via MBSFN. Generating a redundancy version of the MBSFN signal includes applying forward error correction (FEC) on the retrieved at least one source symbol to generate at least one repair symbol. Thus, a redundancy version of the MBSFN signal includes the at least one repair symbol and a subset of the at least one source symbol.

### CROSS-REFERENCE TO RELATED APPLICATION(S)

This application claims the benefit of U.S. Provisional Application Ser. No. 61/722,666, entitled “EMBMS SUPPORT IN HETEROGENEOUS NETWORK” and filed on Nov. 5, 2012, which is expressly incorporated by reference herein in its entirety.

### BACKGROUND

1. Field

The present disclosure relates generally to communication systems, and more particularly, to supporting enhanced multimedia broadcast multicast services (eMBMS) in a heterogeneous network.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus for wireless communication at a node are provided. The apparatus receives a multicast-broadcast single frequency network (MBSFN) signal transmitted from a base station, decodes the received MBSFN signal, and retrieves at least one source symbol from the decoded MBSFN signal when the node is capable of retrieving a source symbol. The apparatus also generates at least one redundancy version of the MBSFN signal based on the retrieved at least one source symbol and transmits the at least one redundancy version of the MBSFN signal. Generating a redundancy version of the MBSFN signal includes applying forward error correction (FEC) on the retrieved at least one source symbol to generate at least one repair symbol. Thus, a redundancy version of the MBSFN signal includes the at least one repair symbol and a subset of the at least one source symbol.

In a further aspect, the apparatus receives scheduling information from the base station, decodes the received scheduling information when the node is capable of decoding scheduling information, and transmits the at least one redundancy version of the MBSFN signal according to the decoded scheduling information. The apparatus refrains from transmitting a signal on an MBSFN symbol when the node is incapable of retrieving a source symbol or incapable of decoding scheduling information.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating a range expanded cellular region in a heterogeneous network.

FIG. 8A is a diagram illustrating an example of an evolved Multimedia Broadcast Multicast Service channel configuration in a Multicast Broadcast Single Frequency Network.

FIG. 8B is a diagram illustrating a format of a Multicast Channel Scheduling Information Media Access Control control element.

FIG. 9 is a diagram illustrating a wireless communication network.

FIG. 10 is a diagram illustrating an architecture for supporting eMBMS at a relay node.

FIG. 11 is a flow chart of a method of wireless communication.

FIG. 12 is a conceptual data flow diagram illustrating the data flow between different modules/means/components in an exemplary apparatus.

FIG. 13 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

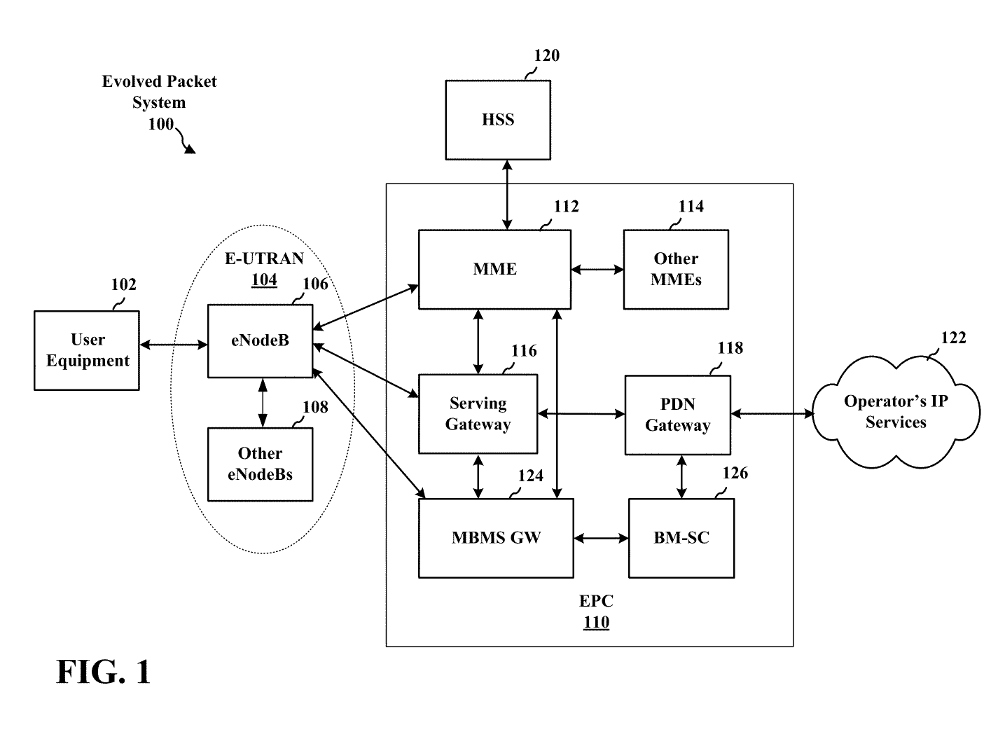

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 includes a Mobility

Management Entity (MME) 112, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS). The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

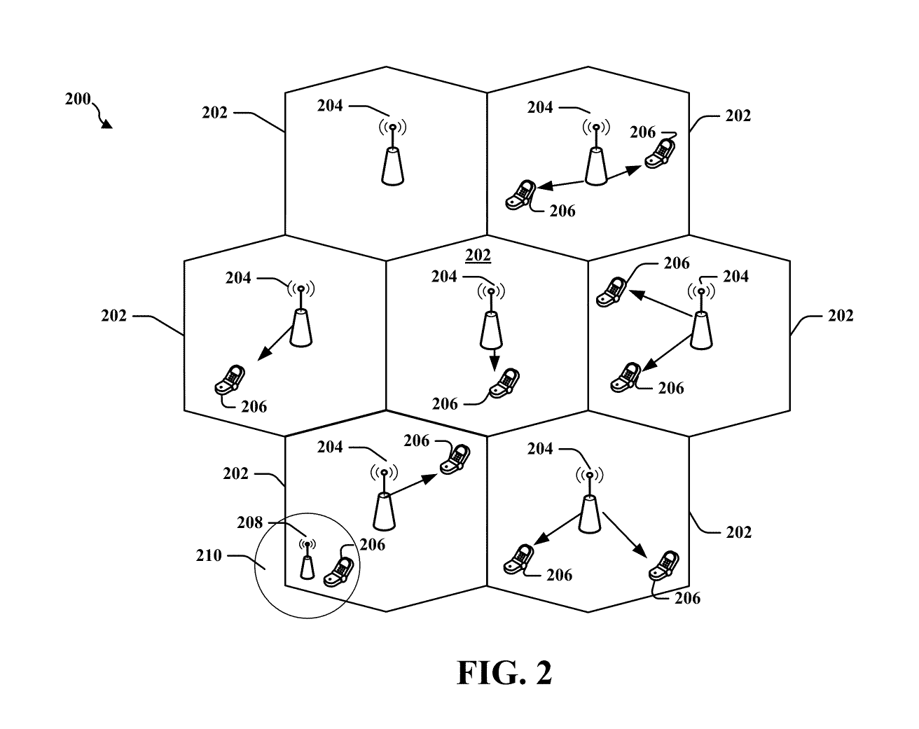

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sector). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

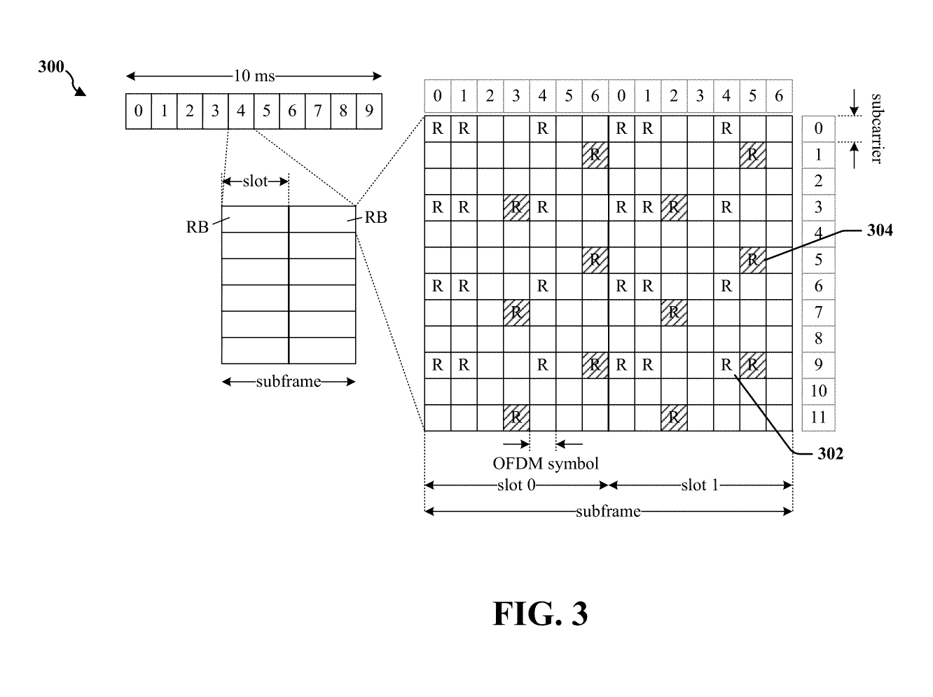

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

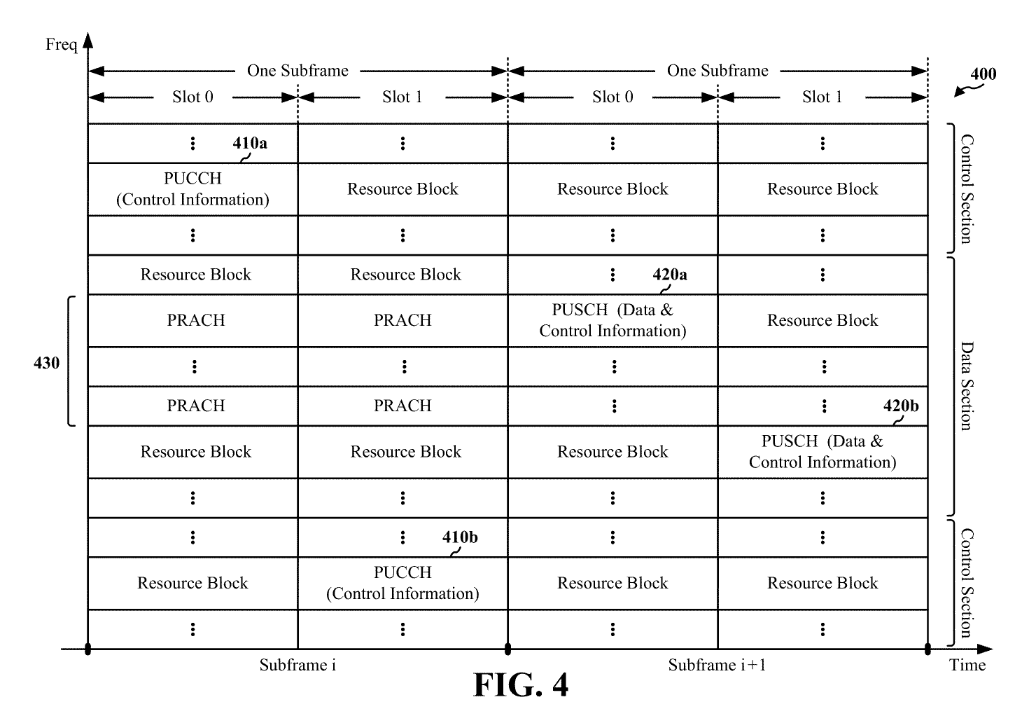

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

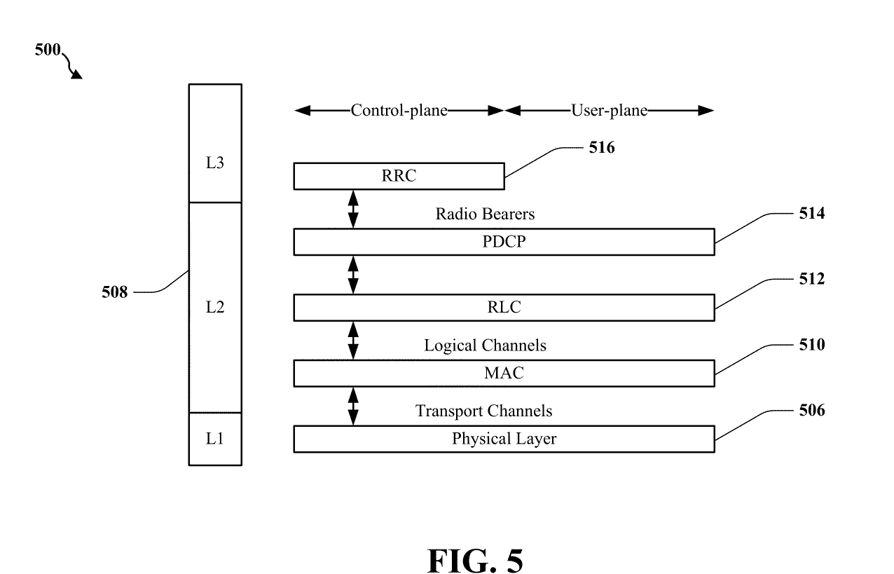

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

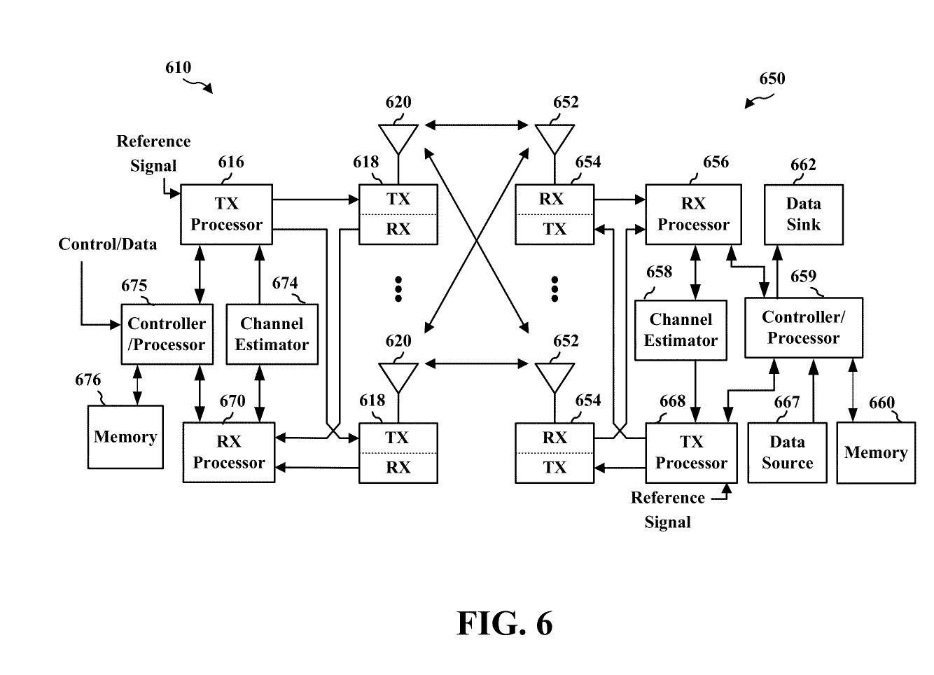

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream may be spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX may receive a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

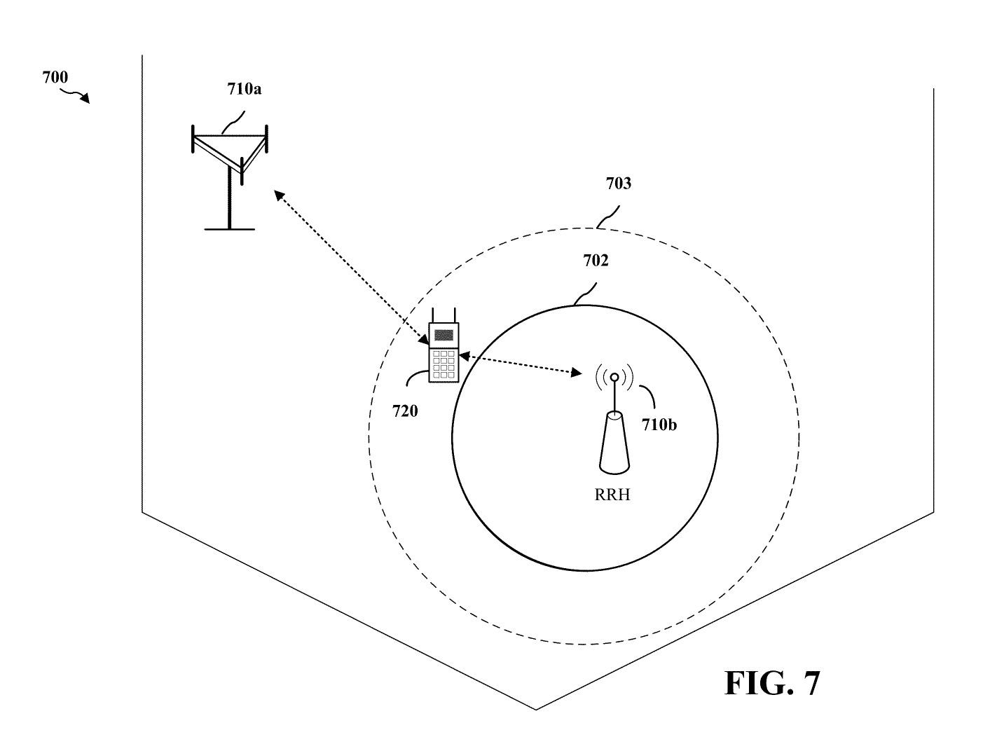

FIG. 7 is a diagram 700 illustrating a range expanded cellular region in a heterogeneous network. A lower power class eNB such as the RRH 710b may have a range expanded cellular region 703 that is expanded from the cellular region 702 through enhanced inter-cell interference coordination between the RRH 710b and the macro eNB 710a and through interference cancellation performed by the UE 720. In enhanced inter-cell interference coordination, the RRH 710b receives information from the macro eNB 710a regarding an interference condition of the UE 720. The information allows the RRH 710b to serve the UE 720 in the range expanded cellular region 703 and to accept a handoff of the UE 720 from the macro eNB 710a as the UE 720 enters the range expanded cellular region 703.

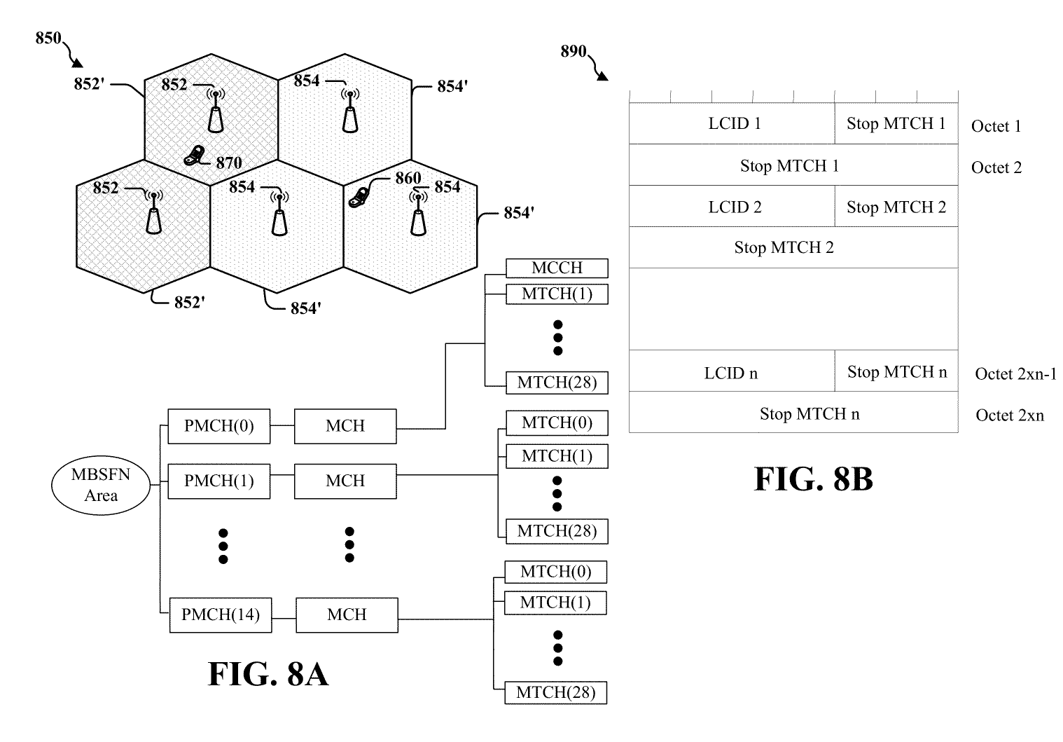

FIG. 8A is a diagram 850 illustrating an example of an evolved MBMS (eMBMS) channel configuration in an MBSFN. The eNBs 852 in cells 852′ may form a first MBSFN area and the eNBs 854 in cells 854′ may form a second MBSFN area. The eNBs 852, 854 may each be associated with other MBSFN areas, for example, up to a total of eight MBSFN areas. A cell within an MBSFN area may be designated a reserved cell. Reserved cells may not provide multicast/broadcast content, but may be time-synchronized to the cells 852′, 854′ and have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 8A, the first MBSFN area may support a first eMBMS broadcast service, such as by providing a particular news broadcast to UE 870. The second MBSFN area may support a second eMBMS broadcast service, such as by providing a different news broadcast to UE 860. Each MBSFN area supports a plurality of physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

A UE can camp on an LTE cell to discover the availability of eMBMS service access and a corresponding access stratum configuration. In a first step, the UE acquires a system information block (SIB) 13 (SIB13). In a second step, based on the SIB13, the UE acquires an MBSFN Area Configuration message on an MCCH. In a third step, based on the MBSFN Area Configuration message, the UE acquires an MCH scheduling information (MSI) MAC control element. The SIB 13 indicates (1) an MBSFN area identifier of each MBSFN area supported by the cell; (2) information for acquiring the MCCH such as an MCCH repetition period (e.g., 32, 64, . . . , 256 frames), an MCCH offset (e.g., 0, 1, . . . , 10 frames), an MCCH modification period (e.g., 512, 1024 frames), a signaling modulation and coding scheme (MCS), subframe allocation information indicating which subframes of the radio frame as indicated by repetition period and offset can transmit MCCH; and (3) an MCCH change notification configuration. There is one MBSFN Area Configuration message for each MBSFN area. The MBSFN Area Configuration message indicates (1) a temporary mobile group identity (TMGI) and an optional session identifier of each MTCH identified by a logical channel identifier within the PMCH, (2) allocated resources (i.e., radio frames and subframes) for transmitting each PMCH of the MBSFN area and the allocation period (e.g., 4, 8, . . . , 256 frames) of the allocated resources for all the PMCHs in the area, and (3) an MCH scheduling period (MSP) (e.g., 8, 16, 32, . . . , or 1024 radio frames) over which the MSI MAC control element is transmitted.

FIG. 8B is a diagram 890 illustrating the format of an MSI MAC control element. The MSI MAC control element may be sent once each MSP. The MSI MAC control element may be sent in the first subframe of each scheduling period of the PMCH. The MSI MAC control element can indicate the stop frame and subframe of each MTCH within the PMCH. There is one MSI per PMCH per MBSFN area.

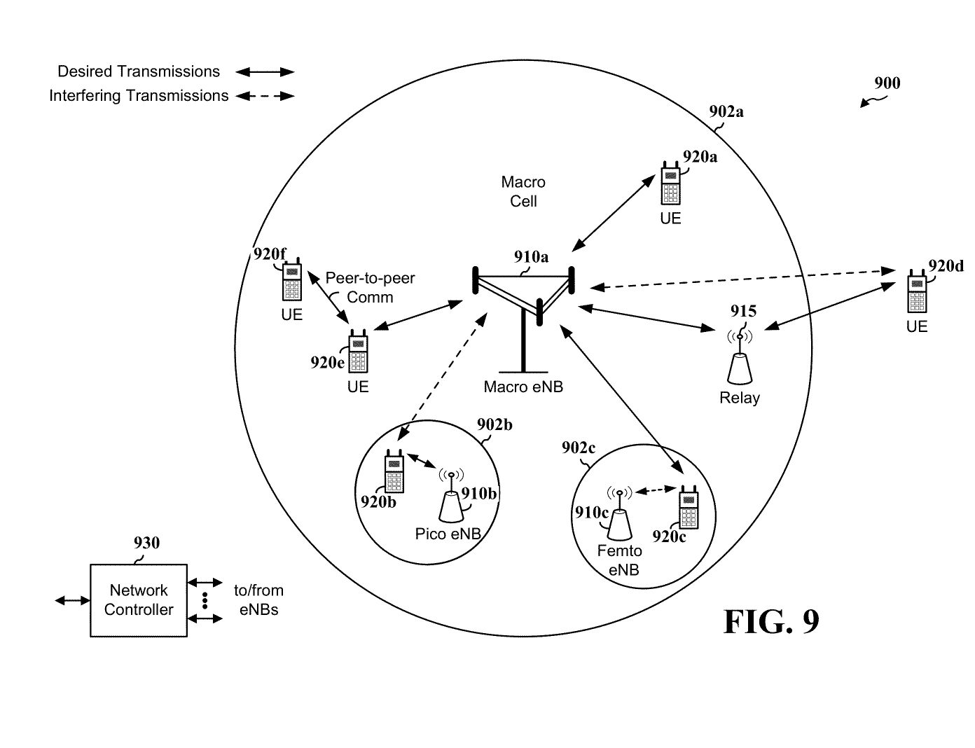

FIG. 9 is a diagram 900 illustrating a wireless communication network, which may be an LTE network or some other wireless network. Wireless network 900 may include a number of evolved Node Bs (eNBs) 910 and other network entities. An eNB may be an entity that communicates with the UEs 920a-920f and may also be referred to as a base station, a Node B, an access point, etc. Each eNB may provide communication coverage for a particular geographic area and may support communication for UEs located within the coverage area. To improve network capacity, the overall coverage area of an eNB may be partitioned into multiple (e.g., three) smaller areas. Each smaller area may be served by a respective eNB subsystem. In 3GPP, the term “cell” can refer to the smallest coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG)). An eNB for a macro cell may be referred to as a macro eNB. An eNB for a pico cell may be referred to as a pico eNB. An eNB for a femto cell may be referred to as a home eNB (HeNB) or a femto eNB. In the example shown in FIG. 9, an eNB 910a may be a macro eNB for a macro cell 902a, an eNB 910b may be a pico eNB for a pico cell 902b, and an eNB 910c may be a femto eNB for a femto cell 902c. An eNB may support one or multiple (e.g., three) cells. The terms “eNB”, “base station”, and “cell” may be used interchangeably herein.

Wireless network 900 may also include relays. A relay may be an entity that can receive a transmission of data from an upstream station (e.g., an eNB or a UE) and send a transmission of the data to a downstream station (e.g., a UE or an eNB). A relay may also be a UE that can relay transmissions for other UEs. In the example shown in FIG. 9, a relay 915 may communicate with macro eNB 910a via a backhaul link and with a UE 920d via an access link in order to facilitate communication between eNB 910a and UE 920d. A relay may also be referred to as a relay node, a relay eNB, a relay station, a relay base station, etc.

Wireless network 900 may be a heterogeneous network that includes eNBs of different types, e.g., macro eNBs, pico eNBs, femto eNBs, relay eNBs, etc. These different types of eNBs may have different transmit power levels, different coverage sizes, and different impact on interference in wireless network 900. For example, macro eNBs may have a high transmit power level (e.g., 5 to 40 Watts) whereas pico eNBs, femto eNBs, and relays may have lower transmit power levels (e.g., 0.1 to 2 Watts).

A network controller 930 may couple to a set of eNBs and may provide coordination and control for these eNBs. Network controller 930 may comprise a single network entity or a collection of network entities. Network controller 930 may communicate with the eNBs via a backhaul. The eNBs may also communicate with one another, e.g., directly or indirectly via a wireless or wireline backhaul.

UEs 920a-920f may be dispersed throughout wireless network 900, and each UE may be stationary or mobile. A UE may also be referred to as a mobile station, a terminal, an access terminal, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a smart phone, a netbook, a smartbook, etc. A UE may be able to communicate with macro eNBs, pico eNBs, femto eNBs, relays, etc. A UE may also be able to communicate peer-to-peer (P2P) with another UE. In the example shown in FIG. 9, UEs 920e and 920f may communicate directly with each other without communicating with an eNB in wireless network 900. P2P communication may reduce the load on wireless network 900 for local communications between UEs. P2P communication between UEs may also allow one UE to act as a relay for another UE, thereby enabling the other UE to connect to an eNB.

Wireless network 900 may utilize FDD or TDD. For FDD, the downlink and uplink may be allocated separate frequency channels, and downlink transmissions and uplink transmissions may be sent concurrently on the two frequency channels. For TDD, the downlink and uplink may share the same frequency channel, and downlink and uplink transmissions may be sent on the same frequency channel in different time periods.

In an aspect of the present disclosure, a pico cell may support enhanced multimedia broadcast multicast services (eMBMS). Accordingly, all pico cells in an MBSFN area may be aware of MBSFN configurations. Moreover, the pico cells may configure MBSFN subframe configuration to conform with macro cells in the MBSFN area.

Two options for implementing a pico cell for supporting eMBMS may be provided. In a first option, the pico cell behaves similar to a macro cell. That is, the pico cell may support all aspects of MBSFN transmission. For example, the pico cell may transmit a system information block (e.g., SIB13), a PDCCH change notification, MCCH, and/or MTCH.

In a second option, certain aspects of MBSFN transmission may be supported. For example, the pico cell may transmit the system information block (e.g., SIB 13) and/or the PDCCH change notification, but may not transmit MCCH and MTCH. In the second option, the pico cell may transmit unicast control signals in a unicast control region of MBSFN subframes but refrain from transmitting signals (data and pilots) on MBSFN symbols (e.g., muting the MBSFN symbols). That is, in the second option, the pico cell does not transmit the MBSFN symbols.

The second option may be applied to relay nodes and femto cells. Regarding relay nodes, signaling may be required to allow a relay node to learn of a SIB13 or PDCCH change notification transmitted from a donor eNB (DeNB). A femto cell may learn of the eNB's SIB 13 or PDCCH change notification via a backhaul link.

Signal-to-noise ratio (SNR) may be improved when a pico cell, relay node, or femto cell transmits eMBMS. For example, an approximately 4 to 5 dB SNR gain may be realized at the 5 percentile of the cumulative distribution function (CDF) of the received SNR across UEs with eight pico cells/relay nodes per macro cell, wherein two UEs are associated with each pico cell/relay node.

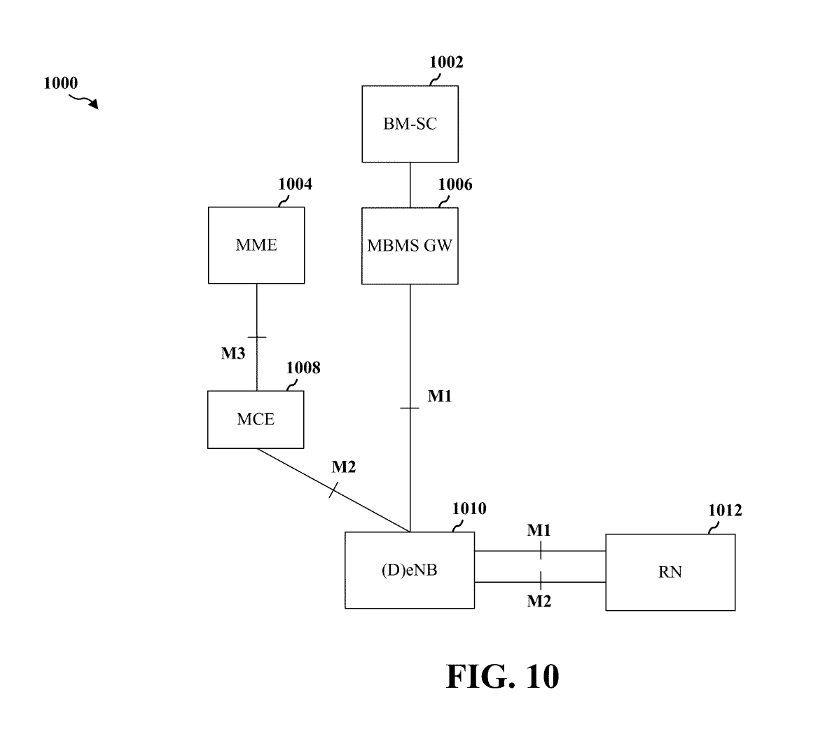

FIG. 10 is a diagram 1000 illustrating an architecture for supporting eMBMS at a relay node. In FIG. 10, a broadcast multicast service center (BM-SC) 1002, a mobility management entity (MME) 1004, an MBMS gateway (GW) 1006, a multicell/multicast coordination entity (MCE) 1008, an eNB 1010, and a relay node (RN) 1012 are depicted. When the relay node 1012 is connected to the eNB 1010, the eNB 1010 may be referred to as a donor eNB (DeNB) 1010.

The BM-SC 1002 is a functional entity in charge of providing a service to a user. The BM-SC 1002 may serve as an entry point for a content source, or any other broadcast/multicast source providing content that is external to an evolved packet system (e.g., EPS 100 of FIG. 1). The MME 1004 is a control node that processes signaling between a UE and evolved packet core. Generally, the MME 1004 provides bearer and connection management. The MBMS GW 1006 may be an entry point of incoming broadcast/multicast traffic and provides corresponding data packets to all eNBs within a service area. The MCE 1008 is responsible for allocating time and frequency resources for multicell MBMS transmission. As such, the MCE 1008 performs scheduling on the radio interface.

Still referring to FIG. 10, an M1 interface represents a user plane interface, an M2 interface represents an E-UTRAN internal control plane interface, and an M3 interface represents a control plane interface between the E-UTRAN and the evolved packet core. In previous architectures, the M1 and M2 interfaces terminated at the DeNB 1010. However, according to the present disclosure, the M1 and M2 interfaces may be extended to the relay node 1012. As such, signals communicated on the M1 interface from the DeNB 1010 to the relay node 1012 may be transmitted via MBSFN signaling. Signals communicated on the M2 interface from the DeNB 1010 to the relay node 1012 may be transmitted via MBSFN signaling or unicast signaling (e.g., via a Uu interface).

Use of a relay node may improve the SNR for MBSFN retransmissions. The improved SNR may allow more source symbols to be sent in the same transmission period without reducing the desired coverage ratio. As such, the system throughput may be improved.

Both MBMS content and signaling may be synchronized to provide MBSFN gain. The BM-SC 1002 and the MME 1004 may not be aware of whether a cell is a relay node or a regular cell. Thus, a latency between the DeNB 1010 and the relay node 1012 should be considered when MBMS content and signaling is forwarded from the DeNB 1010 to the relay node 1012 via a wireless backhaul. The DeNB 1010 may take the latency into consideration when such transmissions are scheduled from the DeNB 1010 to the relay node 1012. The scheduled transmissions may depend on a load of the DeNB 1010 since the DeNB 1010 also serves other unicast users.

A signaling message sent from the DeNB 1010 to the relay node 1012 may occupy an affordable amount of backhaul capacity while the MBMS content data may occupy a large amount of backhaul bandwidth. Therefore, the latency associated with signaling information may be accounted for without difficulty. The latency associated with transferring MBMS data from the DeNB 1010 to the relay node 1012 may be more significant as the backhaul may be overly burdened by such transfer.

In an aspect, in order to resolve the backhaul burden associated with transferring MBMS data from the DeNB 1010 to the relay node 1012, the relay node 1012 may only participate in MBSFN retransmissions. For example, an initial MBSFN transmission may not involve the relay node 1012. Accordingly, during the initial MBSFN transmission, the relay node 1012 would refrain from transmitting signals on MBSFN symbols (e.g., muting the MBSFN symbols) of an MBSFN area. During the initial MBSFN transmission the relay node 1010 may act as a UE and attempt to decode the received MBSFN signal and retrieve original source symbols from the received MBSFN signal. As such, the initial MBMS data transfer from the DeNB 1010 to the relay node 1012 does not require any additional system bandwidth or resources from the backhaul.

The relay node 1012 may apply forward error correction (FEC) to generate subsequent redundancy version(s) of the MBSFN signal based on the retrieved source symbols. A redundancy version of the MBSFN signal may include one or more repair symbols generated from the applied FEC. It may also include one or more of the retrieved source symbols. The redundancy version may be determined by the relay node from a scheduling decision received from the DeNB. The scheduling decision may provide the redundancy version(s) and the time(s) for the retransmission of the redundancy version(s). Typically, the DeNB takes into account the latency required for the relay node to recover and decode the source symbol(s), recover and decode the scheduling decision, and regenerate the redundancy version(s) according to the decoded scheduling decision and source symbols when scheduling the retransmission time(s). It should be noted that a particular redundancy version may specify which source symbols and which repair symbols are included in the MBSFN retransmission. The redundancy version may also specify a modulation and coding scheme (MCS) for the MBSFN retransmission. The relay node 1012 may then transmit the redundancy version(s) of the MBSFN signal according to the scheduling decision without receiving retransmission packets from the BM-SC.

For retransmissions of the MBSFN signal, both the relay node 1012 and the eNB/pico cell transmit the repair symbols. Accordingly, SNR is improved when performing the retransmissions. In an aspect, the relay node 1012 only participating in retransmissions according to the above-described operation may be better suited for file downloading (e.g., using Desktop and mobile Architecture for System Hardware (DASH)) where FEC is used at the application layer, particularly with a lower FEC code rate.

In an aspect, using FEC at the application layer may have various benefits. For example, file delivery based services may benefit from using FEC at the application layer. An FEC scheme may implement RaptorQ code. RaptorQ recovers missing data packets with only minimal amounts of additional repair data and without requiring retransmission from the sender. Accordingly, a file of K systematic symbols may be recovered after receiving any combination of K systematic and repair symbols. Using FEC at the application layer may improve file delivery quality of service (QoS). For example, 95% of users in an MBSFN area may experience 99% successful delivery by applying FEC.

In an example, FEC may be applied at the application layer for a typical suburban deployment having a 2.0 km cell radius. A 200-second transmit time may be utilized. Here, a best rate may be achieved at modulation and coding scheme (MCS) 23 and an application layer FEC code rate 0.56. With a 200-second transmit time, 112 seconds of the transmit time may be used to transmit source symbols while the rest of the transmit time (88 seconds) may be used to transmit repair symbols.

At a 95% coverage ratio, a 5 dB SNR improvement at a UE may be realized with relay node participation. The improved SNR at the UE may allow more source symbols to be transmitted during the transmit time since fewer repair symbols may be needed to recover the transmission. For example, all 88 repair symbols may be considered to be successfully decoded. A number of symbols that can be delivered is approximately (112×0.44)+88=137, wherein 0.44 is an interpolated normalized goodput (FEC code rate) between 100 seconds and 200 seconds. Accordingly, 25 more symbols may be delivered with a corresponding 22% performance improvement.

With application layer FEC, no SNR combining for repair symbols may be utilized. Moreover, only selection combining may be used as undecoded symbols are discarded. If physical layer FEC is utilized, higher performance gain may be expected with SNR combining and improved SNR with relay node participation. Physical layer FEC may involve use of a HARQ buffer.

FEC may be beneficial for file downloading, especially with a longer transmission interval. A higher MBSFN gain may be achieved by using a longer transmission interval. The higher gain may provide better system throughput. Even for DASH based streaming using a 1 to 5 second transmission interval, the MBSFN gain may be sufficient to provide higher system throughput. FEC introduces increased time diversity and improves an overall data rate. When a relay node participates in MBSFN retransmission, a higher FEC code rate and a higher system throughput may be realized. Notably, there may be no physical layer combining for MBMS. When a symbol is in error, it may be discarded. If physical layer combining is provided, higher gain is expected since an effective FEC code rate is expected to be higher.

In an aspect, a procedure for a relay node participating in MBSFN retransmissions will be described. First, an eNB receives a SYNC PDU from a BM-SC. The SYNC PDU includes different redundancy versions of source symbols. The BM-SC may label data with a particular redundancy version and indicate the version to the eNB. The eNB then schedules an initial transmission via MBSFN using a first redundancy version.

The relay node, acting as a UE, receives the initial MBSFN signal from the eNB and attempts to recover the source symbols from the received MBSFN signal. The eNB schedules subsequent redundancy versions and transmits a scheduling decision to the relay node. The scheduling decision may include the redundancy version(s), e.g., specify which source symbols and which repair symbols are to be transmitted in the retransmission(s), and corresponding retransmission time(s). Retransmission time(s) in the scheduling decision accounts for a delay that allows the relay node to recover and decode the source symbols, recover and decode the scheduling decision, and generate the redundancy version(s). The scheduling decision may be transmitted to the relay node via unicast signaling or MBSFN signaling. The same temporary mobile group identifier (TMGI) may be used if the scheduling decision is transmitted via MBSFN. Since the TMGI is a unique identifier for a particular MBMS service, the same TMGI may be used to identify a scheduling decision for the MBMS service when the scheduling decision is transmitted over the MBSFN. The eNB may label the transmitted MBSFN data to inform the relay node that the data conveys the scheduling decision.

For a relay node that is able to decode/retrieve the source symbols and decode the scheduling decision, the relay node generates redundancy version(s) based on the retrieved source symbols and the decoded scheduling decision. The redundancy version(s) may include one or more repair symbols. It may also include one or more source symbols. The relay node then transmits the redundancy version(s) according to the decoded scheduling decision.

For a relay node that is unable to decode the source symbols or the scheduling decision, the relay node refrains from transmitting a signal on MBSFN symbols. That is, the relay node is mute on MBSFN symbols so as not to cause interference.

In an aspect, physical layer retransmission may be provided. Better system performance may be expected if physical layer combining is implemented. With physical layer combining, an initial transmission allows the relay node to decode source data. Retransmissions may be more reliable due to a higher SNR associated with the relay node's participation. Incremental redundancy gain may also be achieved compared to a single transmission. Also, no uplink feedback is required. A retransmission may occur at pre-determined instances with pre-determined redundancy versions. If the retransmission is scheduled, the eNB sends scheduling information to a relay node via unicast signaling or MBSFN signaling. The eNB provides for enough of a delay between each transmission to allow the relay node to decode the source data and/or the scheduling information.

In an aspect, MBSFN signaling may be used for a backhaul transmission of unicast data from an eNB to a relay node. Multiple eNBs may send the same backhaul unicast data to the relay node (RN) via MBSFN. Because MBSFN is associated with increased SNR, the relay node can receive the backhaul unicast data with higher reliability. Such a mechanism may be useful when the relay node is not in a good coverage area of a particular eNB, and may therefore rely on MBSFN signaling to improve backhaul reception.

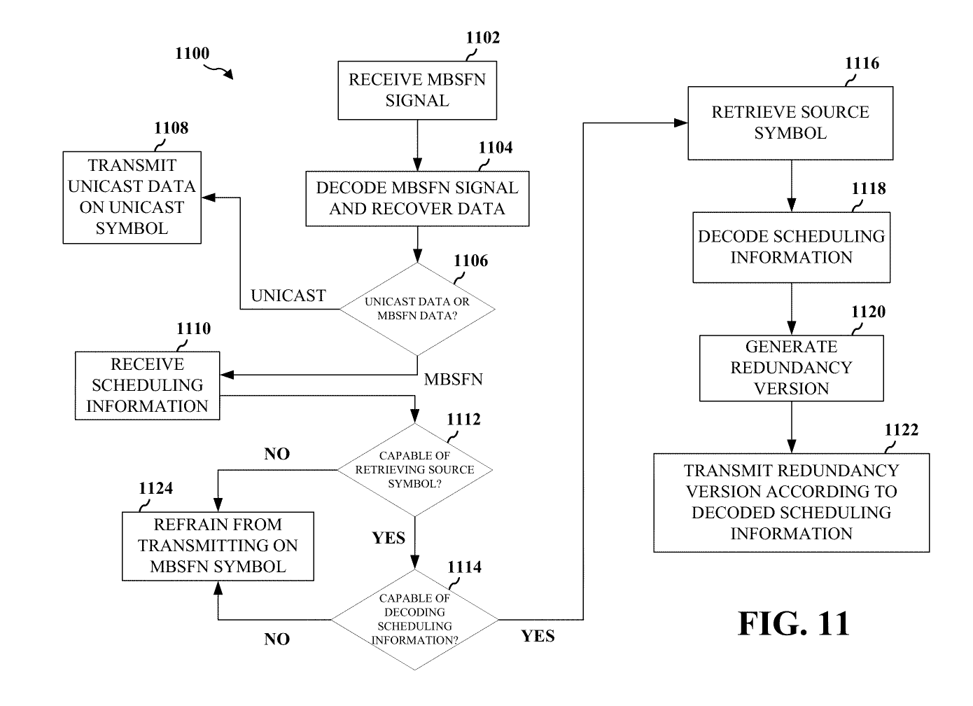

FIG. 11 is a flow chart 1100 of a method of wireless communication. The method may be performed by a node, such as a relay node (e.g., UE), a pico cell, or a femto cell. At step 1102, the node receives a multicast-broadcast single frequency network (MBSFN) signal transmitted from a base station. At step 1104, the node decodes the received MBSFN signal and recovers data from the decoded signal. At step 1106, the node determines whether the recovered data is for a unicast transmission (e.g., unicast data) or for a MBSFN transmission (e.g., MBSFN data). At step 1108, when the node determines that the recovered data is unicast data, the node transmits the unicast data on at least one unicast symbol.

At step 1110, when the node determines that the recovered data is MBSFN data, the node may receive scheduling information from the base station. The scheduling information may be received via a unicast signal or an MBSFN signal, and may include a redundancy version of the MBSFN signal and/or a time for transmitting a redundancy version of the MBSFN signal.

At step 1112, the node determines whether it is capable of retrieving at least one source symbol from the decoded MBSFN signal (e.g., by decoding the signal and performing a CRC check—if the CRC does not pass, the node determines that a source symbol cannot be retrieved). When the node determines the capability of retrieving the at least one source symbol, at step 1114, the node determines whether it is capable of decoding the received scheduling information (e.g., by performing a CRC check on the scheduling information) if retransmission is not predetermined. At step 1124, when the node determines that it is incapable of retrieving at least one source symbol or incapable of decoding the scheduling information, the node refrains from transmitting a signal on an MBSFN symbol.

At step 1116, when the node determines the capability to retrieve at least one source symbol and decode the scheduling information, the node retrieves at least one source symbol from the decoded MBSFN signal. At step 1118, the node decodes the received scheduling information. The scheduling information may include a redundancy version of the MBSFN signal (e.g., specify which source symbols and which repair symbols are to be transmitted in a retransmission) and a retransmission time. The scheduling information may also specify an MCS for the retransmission. At step 1120, the node generates at least one redundancy version of the MBSFN signal based on the retrieved at least one source symbol and the decoded scheduling information. Generating at least one redundancy version of the MBSFN signal may include applying forward error correction (FEC) on the retrieved at least one source symbol to generate at least one repair symbol. Accordingly, the at least one redundancy version of the MBSFN signal may include the at least one repair symbol. The at least one redundancy version may also include a subset of the at least one source symbol. At step 1122, the node transmits the at least one redundancy version of the MBSFN signal according to the decoded scheduling information. The node may transmit the at least one redundancy version of the MBSFN signal synchronously with the base station's transmission of the at least one redundancy version of the MBSFN signal.

In an aspect, the node supports all aspects of MBSFN transmission. For example, the node may support transmission of at least one of a system information block (e.g., SIB13), a physical downlink control channel (PDCCH) change notification, an MBMS control channel (MCCH), or an MBMS traffic channel (MTCH).

In another aspect, the node may only support certain aspects of MBSFN transmission. For example, the node may only support transmission of at least one of the system information block (e.g., SIB13) or the PDCCH change notification. Moreover, in an MBSFN subframe, the node may transmit a unicast control signal in a unicast control region but refrains from transmitting a signal on an MBSFN symbol.

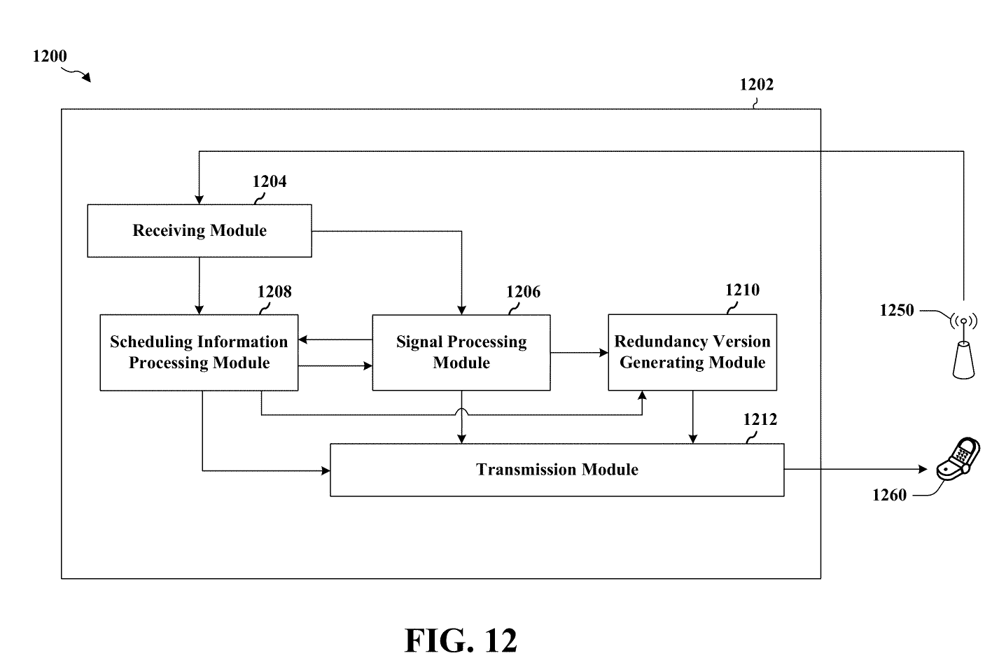

FIG. 12 is a conceptual data flow diagram 1200 illustrating the data flow between different modules/means/components in an exemplary apparatus 1202. The apparatus may be a node, such as a relay node (e.g., UE), a pico cell, or a femto cell. The apparatus includes a receiving module 1204, a signal processing module 1206, a scheduling information processing module 1208, a redundancy version generating module 1210, and transmission module 1212.

The signal processing module 1206 receives (via the receiving module 1204) a multicast-broadcast single frequency network (MBSFN) signal transmitted from a base station 1250. The signal processing module 1206 decodes the received MBSFN signal and recovers data from the decoded signal. The signal processing module 1206 then determines whether the recovered data is for a unicast transmission (e.g., unicast data) or for a MBSFN transmission (e.g., MBSFN data). When the signal processing module 1206 determines that the recovered data is unicast data, the signal processing module 1206 transmits (via the transmission module 1212) the unicast data on at least one unicast symbol.

When the signal processing module 1206 determines that the recovered data is MBSFN data, the scheduling information processing module 1208 may receive (via the receiving module 1204) scheduling information from the base station 1250. The scheduling information may be received via a unicast signal or an MBSFN signal, and may include a redundancy version of the MBSFN signal and/or a time for transmitting a redundancy version of the MBSFN signal.

The signal processing module 1206 determines whether it is capable of retrieving at least one source symbol from the decoded MBSFN signal e.g., by decoding the signal and performing a CRC check. If the CRC does not pass, the signal processing module 1206 determines that the at least one source symbol cannot be retrieved. When the signal processing module 1206 determines a capability of retrieving the at least one source symbol, the scheduling information processing module 1208 determines whether it is capable of decoding the received scheduling information (e.g., by performing a CRC check on the scheduling information). When the signal processing module 1206 determines that it is incapable of retrieving the at least one source symbol or the scheduling information processing module 1208 determines that is incapable of decoding the scheduling information, the transmission module 1212 refrains from transmitting a signal on an MBSFN symbol to a UE 1260, for example.

When the signal processing module 1206 determines the capability to retrieve the at least one source symbol and the scheduling information processing module 1208 determines the capability to decode the scheduling information, the signal processing module 1206 retrieves at least one source symbol from the decoded MBSFN signal. Thereafter, the scheduling information processing module 1208 decodes the received scheduling information. The scheduling information may include a redundancy version of the MBSFN signal (e.g., specify which source symbols and which repair symbols are to be transmitted in a retransmission) and a retransmission time. The scheduling information may also specify an MCS for the retransmission. The redundancy version generating module 1210 generates at least one redundancy version of the MBSFN signal based on the retrieved at least one source symbol and the decoded scheduling information. Generating at least one redundancy version of the MBSFN signal may include applying forward error correction (FEC) on the retrieved at least one source symbol to generate at least one repair symbol. Accordingly, the at least one redundancy version of the MBSFN signal may include the at least one repair symbol. The at least one redundancy version may also include a subset of the at least one source symbol. The transmission module 1212 transmits the at least one redundancy version of the MBSFN signal according to the decoded scheduling information. The transmission module 1212 may transmit the at least one redundancy version of the MBSFN signal synchronously with the transmission of the at least one redundancy version of the MBSFN signal from the base station 1250.

In an aspect, the apparatus 1202 supports all aspects of MBSFN transmission. For example, the apparatus 1202 may support transmission of at least one of a system information block (e.g., SIB13), a physical downlink control channel (PDCCH) change notification, an MBMS control channel (MCCH), or an MBMS traffic channel (MTCH).

In another aspect, the apparatus 1202 may only support certain aspects of MBSFN transmission. For example, the node may only support transmission of at least one of the system information block (e.g., SIB13) or the PDCCH change notification. Moreover, in an MBSFN subframe, the apparatus 1202 may transmit a unicast control signal in a unicast control region but refrains from transmitting a signal on an MBSFN symbol.

The apparatus may include additional modules that perform each of the steps of the algorithm in the aforementioned flow chart of FIG. 11. As such, each step in the aforementioned flow charts of FIG. 11 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

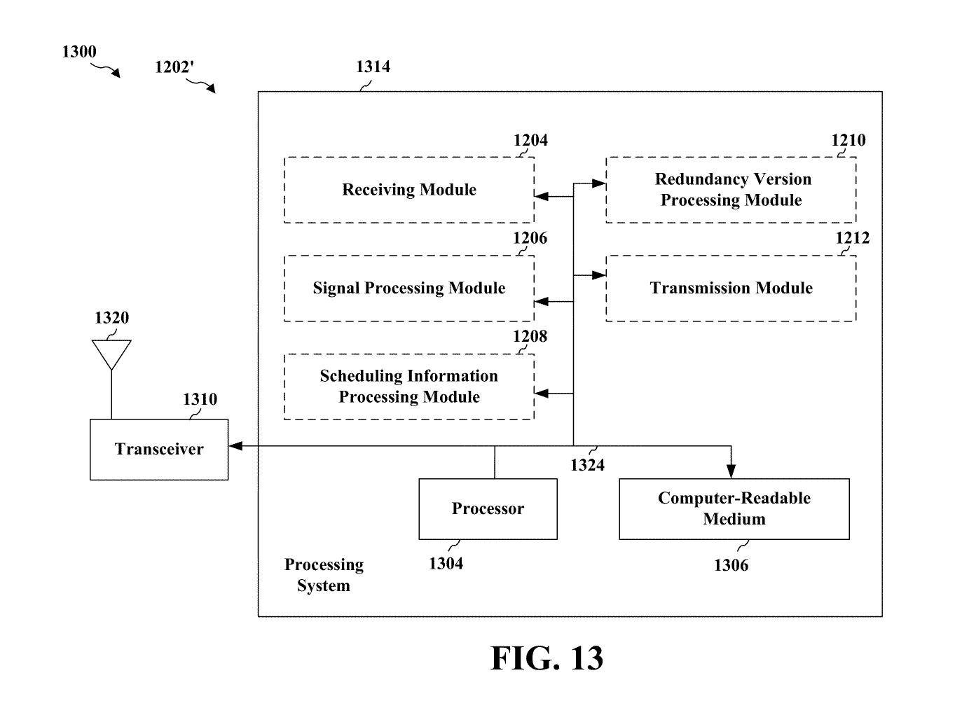

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware modules, represented by the processor 1304, the modules 1204, 1206, 1208, 1210, 1212 and the computer-readable medium 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The transceiver 1310 receives a signal from the one or more antennas 1320, extracts information from the received signal, and provides the extracted information to the processing system 1314, specifically the receiving module 1204. In addition, the transceiver 1310 receives information from the processing system 1314, specifically the transmission module 1212, and based on the received information, generates a signal to be applied to the one or more antennas 1320. The processing system 1314 includes a processor 1304 coupled to a computer-readable medium 1306. The processor 1304 is responsible for general processing, including the execution of software stored on the computer-readable medium 1306. The software, when executed by the processor 1304, causes the processing system 1314 to perform the various functions described supra for any particular apparatus. The computer-readable medium 1306 may also be used for storing data that is manipulated by the processor 1304 when executing software. The processing system further includes at least one of the modules 1204, 1206, 1208, 1210, and 1212. The modules may be software modules running in the processor 1304, resident/stored in the computer readable medium 1306, one or more hardware modules coupled to the processor 1304, or some combination thereof. The processing system 1314 may be a component of the eNB 610 and may include the memory 676 and/or at least one of the TX processor 616, the RX processor 670, and the controller/processor 675. The processing system 1314 may be a component of the UE 650 and may include the memory 660 and/or at least one of the TX processor 668, the RX processor 656, and the controller/processor 659.

In one configuration, the apparatus 1202/1202′ for wireless communication includes means for receiving a multicast-broadcast single frequency network (MBSFN) signal transmitted from a base station, means for decoding the received MBSFN signal, means for recovering data from the decoded MBSFN signal, means for determining whether the recovered data is unicast data or MBSFN data, means for retrieving at least one source symbol from the decoded MBSFN signal when the node is capable of retrieving a source symbol, means for generating at least one redundancy version of the MBSFN signal based on the retrieved at least one source symbol, means for transmitting the at least one redundancy version of the MBSFN signal, means for receiving scheduling information from the base station, means for decoding the received scheduling information when the node is capable of decoding scheduling information, means for transmitting the at least one redundancy version of the MBSFN signal according to the decoded scheduling information, and means for refraining from transmitting a signal on an MBSFN symbol when the node is incapable of retrieving a source symbol or incapable of decoding scheduling information.

The aforementioned means may be one or more of the aforementioned modules of the apparatus 1202 and/or the processing system 1314 of the apparatus 1202′ configured to perform the functions recited by the aforementioned means. As described supra, the processing system 1314 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means. Alternatively, as described supra, the processing system 1314 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication at a node, comprising:
receiving a multicast-broadcast single frequency network (MBSFN) signal transmitted from a base station;
decoding the received MBSFN signal;
recovering data from the decoded MBSFN signal; and
determining whether the recovered data is unicast data or MBSFN data.

2. The method of claim 1, wherein the recovered data is MBSFN data, the method further comprising:
retrieving at least one source symbol from the decoded MBSFN signal when the node is capable of retrieving a source symbol;
generating at least one redundancy version of the MBSFN signal based on the retrieved at least one source symbol; and
transmitting the at least one redundancy version of the MBSFN signal via MBSFN.

3. The method of claim 2, wherein the at least one redundancy version of the MBSFN signal is synchronously transmitted with a transmission of the at least one redundancy version of the MBSFN signal from the base station.

4. The method of claim 2, the generating at least one redundancy version of the MBSFN signal comprising applying forward error correction (FEC) on the retrieved at least one source symbol to generate at least one repair symbol, the at least one redundancy version of the MBSFN signal comprising the at least one repair symbol and a subset of the at least one source symbol.

5. The method of claim 2, further comprising:
receiving scheduling information from the base station;
decoding the received scheduling information when the node is capable of decoding scheduling information; and
transmitting the at least one redundancy version of the MBSFN signal according to the decoded scheduling information.

6. The method of claim 5, wherein the scheduling information comprises at least one of:
a redundancy version; or
a time for transmitting the at least one redundancy version of the MBSFN signal.

7. The method of claim 5, wherein the scheduling information is received via a unicast signal or an MBSFN signal.

8. The method of claim 5, further comprising refraining from transmitting a signal on an MBSFN symbol when the node is incapable of retrieving a source symbol or incapable of decoding scheduling information.

9. The method of claim 8, wherein the node is one of a relay node, a pico cell, or a femto cell.

10. The method of claim 2, wherein the node supports transmission of at least one of a system information block, a physical downlink control channel (PDCCH) change notification, an MBMS control channel (MCCH), or an MBMS traffic channel (MTCH).

11. The method of claim 10, wherein the node is one of a relay node, a pico cell, or a femto cell.

12. The method of claim 2, wherein the node supports transmission of at least one of a system information block or a physical downlink control channel (PDCCH) change notification.

13. The method of claim 12, wherein in an MBSFN subframe, the node transmits a unicast control signal in a unicast control region and refrains from transmitting a signal on an MBSFN symbol.

14. The method of claim 13, wherein the node is one of a relay node, a pico cell, or a femto cell.

15. An apparatus for wireless communication at a node, comprising:
means for receiving a multicast-broadcast single frequency network (MBSFN) signal transmitted from a base station;
means for decoding the received MBSFN signal;
means for recovering data from the decoded MBSFN signal; and
means for determining whether the recovered data is unicast data or MBSFN data.

16. The apparatus of claim 15, wherein the recovered data is MBSFN data, the apparatus further comprising:
means for retrieving at least one source symbol from the decoded MBSFN signal when the node is capable of retrieving a source symbol;
means for generating at least one redundancy version of the MBSFN signal based on the retrieved at least one source symbol; and
means for transmitting the at least one redundancy version of the MBSFN signal via MBSFN.

17. The apparatus of claim 16, wherein the means for transmitting is configured to transmit the at least one redundancy version of the MBSFN signal synchronously with a transmission of the at least one redundancy version of the MBSFN signal from the base station.

18. The apparatus of claim 16, the means for generating at least one redundancy version of the MBSFN signal configured to apply forward error correction (FEC) on the retrieved at least one source symbol to generate at least one repair symbol, the at least one redundancy version of the MBSFN signal comprising the at least one repair symbol and a subset of the at least one source symbol.

19. The apparatus of claim 16, further comprising:
means for receiving scheduling information from the base station;
means for decoding the received scheduling information when the node is capable of decoding scheduling information; and
means for transmitting the at least one redundancy version of the MBSFN signal according to the decoded scheduling information.

20. The apparatus of claim 19, wherein the scheduling information comprises at least one of:
a redundancy version; or
a time for transmitting the at least one redundancy version of the MBSFN signal.

21. The apparatus of claim 19, wherein the scheduling information is received via a unicast signal or an MBSFN signal.

22. The apparatus of claim 19, further comprising means for refraining from transmitting a signal on an MBSFN symbol when the node is incapable of retrieving a source symbol or incapable of decoding scheduling information.

23. The apparatus of claim 22, wherein the node is one of a relay node, a pico cell, or a femto cell.

24. The apparatus of claim 16, wherein the node supports transmission of at least one of a system information block, a physical downlink control channel (PDCCH) change notification, an MBMS control channel (MCCH), or an MBMS traffic channel (MTCH).

25. The apparatus of claim 24, wherein the node is one of a relay node, a pico cell, or a femto cell.

26. The apparatus of claim 16, wherein the node supports transmission of at least one of a system information block or a physical downlink control channel (PDCCH) change notification.

27. The apparatus of claim 26, wherein in an MBSFN subframe, the node transmits a unicast control signal in a unicast control region and refrains from transmitting a signal on an MBSFN symbol.

28. The apparatus of claim 27, wherein the node is one of relay node, a pico cell, or a femto cell.

29. An apparatus for wireless communication at a node, comprising:
a processing system configured to:
receive a multicast-broadcast single frequency network (MBSFN) signal transmitted from a base station;
decode the received MBSFN signal;
recover data from the decoded MBSFN signal; and
determine whether the recovered data is unicast data or MBSFN data.

30. The apparatus of claim 29, wherein the recovered data is MBSFN data, the processing system further configured to:
retrieve at least one source symbol from the decoded MBSFN signal when the node is capable of retrieving a source symbol;
generate at least one redundancy version of the MBSFN signal based on the retrieved at least one source symbol; and
transmit the at least one redundancy version of the MBSFN signal via MBSFN.

31. The apparatus of claim 30, wherein processing system configured to transmit is further configured to transmit the at least one redundancy version of the MBSFN signal synchronously with a transmission of the at least one redundancy version of the MBSFN signal from the base station.

32. The apparatus of claim 30, the processing system configured to generate at least one redundancy version of the MBSFN signal further configured to apply forward error correction (FEC) on the retrieved at least one source symbol to generate at least one repair symbol, the at least one redundancy version of the MBSFN signal comprising the at least one repair symbol and a subset of the at least one source symbol.

33. The apparatus of claim 30, the processing system further configured to:
receive scheduling information from the base station;
decode the received scheduling information when the node is capable of decoding scheduling information; and
transmit the at least one redundancy version of the MBSFN signal according to the decoded scheduling information.

34. The apparatus of claim 33, wherein the scheduling information comprises at least one of:
a redundancy version; or
a time for transmitting the at least one redundancy version of the MBSFN signal.

35. The apparatus of claim 33, wherein the scheduling information is received via a unicast signal or an MBSFN signal.

36. The apparatus of claim 33, the processing system further configured to refrain from transmitting a signal on an MBSFN symbol when the node is incapable of retrieving a source symbol or incapable of decoding scheduling information.

37. The apparatus of claim 36, wherein the node is one of a relay node, a pico cell, or a femto cell.

38. The apparatus of claim 30, wherein the node supports transmission of at least one of a system information block, a physical downlink control channel (PDCCH) change notification, an MBMS control channel (MCCH), or an MBMS traffic channel (MTCH).

39. The apparatus of claim 38, wherein the node is one of relay node, a pico cell, or a femto cell.

40. The apparatus of claim 30, wherein the node supports transmission of at least one of a system information block or a physical downlink control channel (PDCCH) change notification.

41. The apparatus of claim 40, wherein in an MBSFN subframe, the node transmits a unicast control signal in a unicast control region and refrains from transmitting a signal on an MBSFN symbol.

42. The apparatus of claim 41, wherein the node is one of relay node, a pico cell, or a femto cell.

43. A computer program product of a node, comprising:
a computer-readable medium comprising code for:
receiving a multicast-broadcast single frequency network (MBSFN) signal transmitted from a base station;
decoding the received MBSFN signal;
recovering data from the decoded MBSFN signal; and
determining whether the recovered data is unicast data or MBSFN data

44. The computer program product of claim 43, wherein the recovered data is MBSFN data, the computer-readable medium further comprising code for:
retrieving at least one source symbol from the decoded MBSFN signal when the node is capable of retrieving a source symbol;
generating at least one redundancy version of the MBSFN signal based on the retrieved at least one source symbol; and
transmitting the at least one redundancy version of the MBSFN signal via MBSFN.

45. The computer program product of claim 44, wherein the code for transmitting is configured to transmit the at least one redundancy version of the MBSFN signal synchronously with a transmission of the at least one redundancy version of the MBSFN signal from the base station.

46. The computer program product of claim 44, the code for generating at least one redundancy version of the MBSFN signal configured to apply forward error correction (FEC) on the retrieved at least one source symbol to generate at least one repair symbol, the at least one redundancy version of the MBSFN signal comprising the at least one repair symbol and a subset of the at least one source symbol.

47. The computer program product of claim 44, the computer-readable medium further comprising code for:
receiving scheduling information from the base station;
decoding the received scheduling information when the node is capable of decoding scheduling information; and
transmitting the at least one redundancy version of the MBSFN signal according to the decoded scheduling information.

48. The computer program product of claim 47, wherein the scheduling information comprises at least one of:
a redundancy version; or
a time for transmitting the at least one redundancy version of the MBSFN signal.

49. The computer program product of claim 47, wherein the scheduling information is received via a unicast signal or an MBSFN signal.

50. The computer program product of claim 47, the computer-readable medium further comprising code for refraining from transmitting a signal on an MBSFN symbol when the node is incapable of retrieving a source symbol or incapable of decoding scheduling information.

51. The computer program product of claim 50, wherein the node is one of a relay node, a pico cell, or a femto cell.

52. The computer program product of claim 44, wherein the node supports transmission of at least one of a system information block, a physical downlink control channel (PDCCH) change notification, an MBMS control channel (MCCH), or an MBMS traffic channel (MTCH).

53. The computer program product of claim 52, wherein the node is one of relay node, a pico cell, or a femto cell.

54. The computer program product of claim 44, wherein the node supports transmission of at least one of a system information block or a physical downlink control channel (PDCCH) change notification.

55. The computer program product of claim 54, wherein in an MBSFN subframe, the node transmits a unicast control signal in a unicast control region and refrains from transmitting a signal on an MBSFN symbol.

56. The computer program product of claim 55, wherein the node is one of a relay node, a pico cell, or a femto cell.
